(19) United States
(12) Patent Application Publication
(10) Pub. No.: US 2006/0096409 A1
(43) Pub. Date: May 11, 2006

(54) Steering wheel with electrical heating element

(76) Inventors: Michael Weiss, Benediktbeuren (DE); Martina Rottinger, Munchen (DE); Peter Nagele, Aichach (DE)

Correspondence Address: Robert P Renke;Artz & Artz, Suite 250, 28333 Telegraph Road, Southfield, MI, 48034, US

(21) Appl. No.: 10/519,280

(22) PCT Filed: Jun. 6, 2003
(86) PCT No.: PCT/DE03/01892

§ 371 Date: Aug. 12, 2005

(30) Foreign Application Priority Data
Jun. 28, 2002 (DE) 102 29 247.7

(51) Int. Cl. B62D 1/04

(52) U.S. Cl. 74/552

(57) ABSTRACT

A steering wheel having a padding (24), a grip surface (27) at least partly covering the same, and a heating element (4) arranged between the padding (24) and the grip surface (27), and including an electrically conductive layer (41) with a meandering contour along a direction of the lengthwise extent of the heating element (4). The heating element (4) is cropped from an endless segment and so that the apical segments (45) of the electrically conductive layer (41) are each widened relative to their connecting segments (48).

The invention relates to a steering wheel with electric heating, in particular to an electrically heatable steering wheel for a motor vehicle, according to the generic clause of the independent claim.

Steering wheels with built-in heating devices are known. Such electrically operated heating devices may be provided for reasons of comfort and/or safety. Ordinarily, for heating a steering wheel, a heating conductor is arranged under a steering wheel covering or integrated in a synthetic material foamed around the steering wheel. A steering wheel rim may for example be wound with a heating conductor or enveloped in a conductive textile tube. A linear or meandering placement of a strand along the circumference of the steering wheel is also possible and known.

A conventional steering wheel comprises a round or slightly oval steering wheel rim, usually consisting in cross section of a metal core, a plastic or foam surrounding it, and an enveloping covering. The latter is often omitted in cheaper steering wheels. In order to heat the steering wheel quickly to a perceptible extent, the heating conductor must be arranged near the surface. Otherwise, it would first unnecessarily heat the metal core of the steering wheel, and thereby occasion a comparatively high consumption of energy. On the other hand, the heating conductor should not be palpable to the steering wheel covering.

According to vehicle model and manufacturer, the steering wheels and the steering wheel rims may be quite differently dimensioned in thickness and diameter. A production of heating elements made to measure for this purpose is therefore comparatively expensive.

A steering wheel with built-in heating device is disclosed in DE 3,339,500 A1. This known steering wheel comprises a grip ring wound with a heat-conductive flat material that generates heat when supplied with current. Besides, a heat-conductive flat material is provided that extends close to and along the actual heating device of the steering wheel, in order to achieve a uniform temperature distribution within a short time in a preassigned region of the steering wheel corresponding to the preferred grip position in driving.

Further, U.S. Pat. No. 4,631,976 A discloses a steering wheel with bipartite heating device. Each part includes a film with electrically heatable conductor tracks thereon. Each part is arranged in a preferred hand grip position of the steering wheel. Each of the conductor paths provided on a supporting film provides a closed contour meandering over the direction of lengthwise extent of the supporting film.

One object of the present invention consists in making available a steering wheel having a universal heating device, easily attached and adapted to various steering wheel sizes.

This object of the invention is accomplished by the subject matter of the independent claim. Features of advantageous refinements of the invention appear from the dependent claims.

Accordingly, a steering wheel comprises a padding, a grip surface at least partly covering the same, and a heating element arranged between the padding and the grip surface. The heating element comprises an electrically conductive layer having a meandering contour along a direction of lengthwise extent of the heating element. According to the invention, provision is made for the heating element to be cropped from an endless segment. Further, provision is made for the electrically conductive layer to be widened at each apical segment relative to its connecting segment.

Such a heating element can be cropped without problems from an endless segment, adapted to various steering wheel sizes, and applied thereto. Thereby a universal heatable steering wheel is obtained that can be produced in simple manner, without requiring a multitude of different sizes of heating elements for different steering wheels. The heating element may be cut to arbitrary lengths at arbitrary points.

In that the electrically conductive layer is in each instance widened relative to the linear or slightly curved connecting segments, it can be prevented that so-called current sinks will arise on the inside of the segments, creating regions of enhanced temperature, referred to as so-called “hot spots.”

Preferably, the electrically conductive layer is an integral constituent of a heating element exhibiting a meandering contour, so that installation on the steering wheel is much simplified by the one-piece heating element. The meandering contour of the heating element may optionally include an undulating, rectangular, saw tooth or triangular profiled.

Preferably the apical segments of the electrically heatable layer or heating element following a meandering contour may comprise an inner and/or an outer radius, rendering the heating element mechanically more stable and providing for a better and more uniform distribution of heat in the steering wheel.

Depending on the contour of the meandering heating element, the envelopes of the apical segments arranged on one side of the direction of lengthwise extent of the heating element may overlap, the apical segments themselves not touching each other. Optionally the envelopes may alternatively be distanced from each other. Depending on the contour of the heating element, an adaptability to definitely different thicknesses of steering wheel rings results.

Depending on the desired embodiment, the heating element may travel around the entire steering wheel circumference or for example cut out a lower circumferential segment of the steering wheel. Preferably, in each instance at least two hand grip positions of the steering wheel are provided with one heating element each, an upper steering wheel segment being either heated throughout or exhibiting a cut-out. In this way, regions seldom gripped can be cut out, reducing the consumption of energy.

According to one embodiment of the invention, the heating element comprises at least two interconnected layers, an electrically conductive layer being applied to an insulating support layer. The insulating support layer may preferably be made of a synthetic material, in particular a polyurethane foam. Since the steering wheel ring of metal or composite fiber material is typically surrounded with polyurethane foam, an especially good pairing of materials results if the support layer is made of the same material. The same materials at the boundary surfaces provide for a uniform thermal expansion and avoid the danger of relative displacements or detachment phenomena.

The electrically heated layer may for example comprise copper and/or a copper alloy, in particular a copper alloy containing tin, exhibiting especially good electrical properties and good heat conductivity. Alternatively, the electrically conductive layer may also comprise aluminum or an aluminum alloy, likewise providing for good heat conductivity. Both copper, or a bronze alloy, and aluminum are good electrical conductors.

The electrically conductive layer may for example be vapor-deposited on the insulating support layer or applied galvanically, or by “sputtering.” By these methods, exact contours and well-defined—including variable—thicknesses of layer can be realized.

According to a further refinement of the invention, the electrically conductive layer at each of its apical segments may comprise a greater material thickness of metallization of the electrically conductive layer than of the linear or slightly curved connecting segments. This may for example be accomplished by modification of the vapor deposition or galvanic process. In sputtering of the electrically conductive layer also, a punctually or areally limited thickening is possible without problems.

The electrically conductive layer comprises several contacting locations for connection of supply lines. These contacting locations preferably each comprise a thickening in the form of a widening and/or a greater thickness of material of the metallization.

Each of the heating elements comprises at least two electrical contactings. It may be advantageous if in the case of an endless heating element brought into its desired form by cropping, contacting locations are provided at regular intervals, of which the most appropriate can be selected for an application.

At each of these electrical contactings, an electrically conductive cable connection is provided, by which an electrically conductive connection to a vehicle network is made possible.

The contactings may, according to alternative embodiments of the invention, take the form of riveted, soldered or bonded connections. Riveted connections are typically realized as metal elements piercing the film; these are designated as so-called piercing contacts. Also, welded connections are possible at which a connection to the electrical leads is made possible by resistance or friction welding. Bonded connections are made in simple manner by means of conductive adhesives. All of the contacting connections named must exhibit a minimum of mechanical stability, since the heating element is arranged immediately under the grip layer, and may be subject in prolonged use to a slight displacement locally relative to the surrounding foam or enveloping grip layer.

Another embodiment of the invention provides that the heating element is bonded underneath the outer grip surface of the steering wheel onto the padding or foam envelopment of the rim, after which the outer grip surface is applied to the heating element and surrounding foam and secured. Alternatively or additionally, the heating element may be bonded to an inside of the outer grip surface applied to the upholstery or enveloping foam of the steering wheel ring. This outer grip surface may essentially comprise natural or artificial leather or the same material as the foaming or padding itself.

According to an embodiment of the invention, the insulating support layer comprises a thickness of material between 30 and 200 p, the thickness lying preferably between 50 and 80 p. Such a thin support film can be adapted without problems to all surfaces to which it is applied.

The electrically conductive layer may have a thickness of material of 50μ maximum, a preferred thickness of material being 20 p maximum. An especially preferred embodiment provides that the electrically conductive layer comprise 10 p maximum. Such a thickness of layer provides for a defined electrical resistance, which in turn provides for a defined heating.

The electrically conductive layer of the heating element preferably comprises no so-called PTC effect, so that the heating element can be operated constantly at full output. A PTC effect would lead to an enhanced heating conductor resistance upon reaching a certain temperature, and hence to a lesser flow of current and a reduced output. Suitable materials for the conductive layer therefore are in particular bronze alloys with copper-tin proportions adapted to each other.

The invention relates further to a heating element according to any of the embodiments previously described, suitable in particular for installation in a steering wheel of a motor vehicle or the like. Such a heating element may be cut to any length from an endless segment and may in this way be adapted to the most various steering wheel sizes, diameters and thicknesses.

Other advantageous embodiments are to be found in the subsidiary claims.

The invention will now be illustrated in more detail in terms of embodiments with reference to the accompanying figures. In the figures,

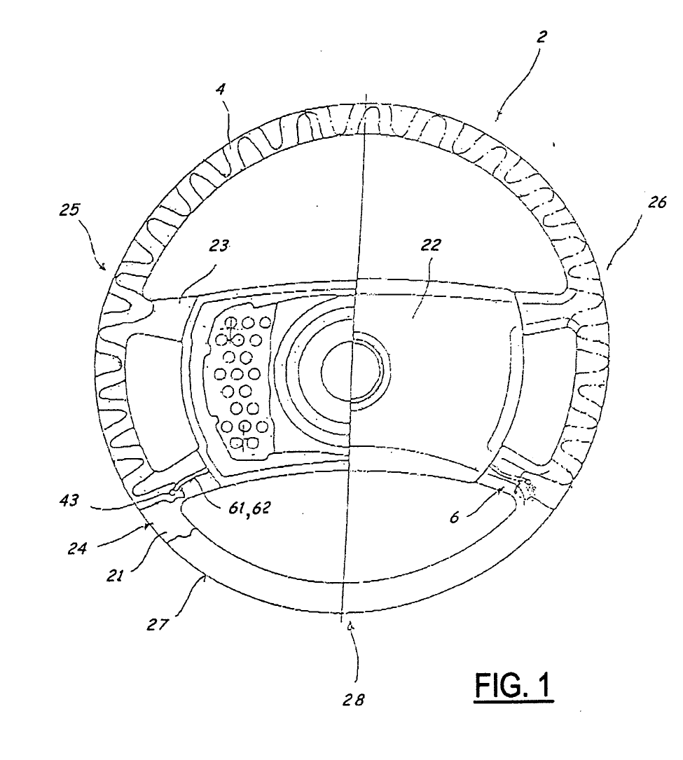

FIG. 1 shows a schematic top view of a steering wheel of a motor vehicle having an integrated heating element, and

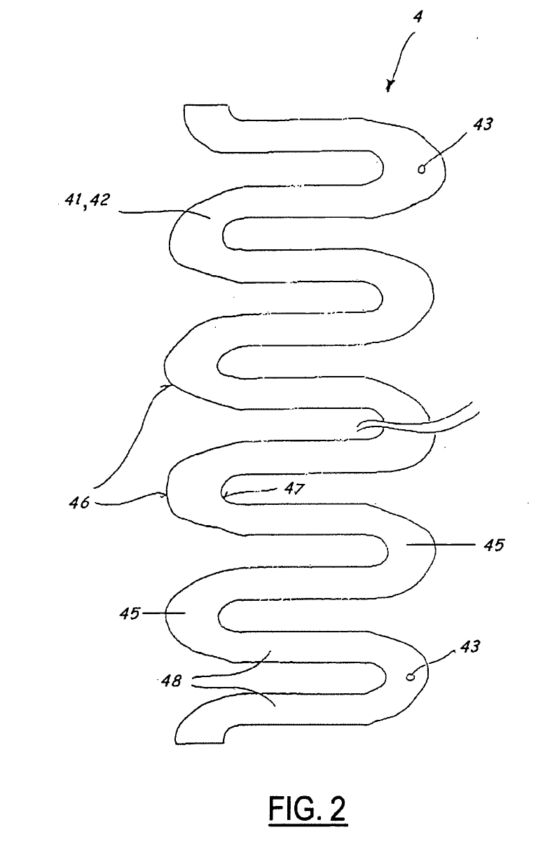

FIG. 2 shows a schematic representation of a heating element according to the invention as in FIG. 1.

FIG. 1 shows a schematic top view of a steering wheel 2 of a motor vehicle. The steering wheel 2 comprises a steering wheel hub 22, fastened by way of at least one steering wheel spoke 23 to an essentially round steering wheel rim 21. In the embodiment shown, four spokes 23 are provided to connect the rim 21 to the hub 22. The spokes 23 and the rim 21 typically exhibit a geometrically stable core (not shown) of metal or a composite fiber material, surrounded by a shock-absorbing foam envelope 24 or padding. This padding or shock-absorbing foam envelope 24 may, for steering wheels 2 of simple construction, be made in one piece, in which case the outer boundary layer is at the same time the grip layer. More grip-friendly versions comprise an outer grip surface 27 of natural leather, applied to the padding or foaming 24 and for example sewn.

The steering wheel 2 shown comprises an electric heating device in the form of a heating element 4, extending at least around a part of the rim 21 of the steering wheel. The heating element 4 comprises a meandering or serpentine course and extends in alternating paths largely around the entire thickness of the rim 21. In the embodiment shown by way of example, the heating element 4 runs from a steering wheel spoke 23 at the lower left by way of a typical left-hand grip position 25 and an upper segment of the steering wheel to a typical right-hand grip position 26 and to a spoke position 23 at the lower right. A lower segment 28 of the rim 21 is recessed and, in the embodiment shown by way of example, not heated.

In the immediate neighborhood of the lower spokes 23, contacting positions 43 are provided at apical segments 45 (cf. FIG. 2) of the heating element 4, at each of which an electrical contacting 6 is made to supply the heating element 4 with electrical energy from the vehicle network. This electrical contacting takes place in the form of a cable connection 62, representing a supply line 61 and electrically conductively connected to the heating element 4 at the contacting location 43. This electrically conductive connection may for example be made in the form of a riveted, soldered, welded or bonded connection. If an upper region of the rim 21 between hand grip positions 25, 26 is cut out as well, then two shorter heating elements 4 are required, each requiring two electrical contactings 6 at their ends.

FIG. 2 shows a schematic representation of a heating element 4 intended for installation in the steering wheel, in the embodiment shown by way of example comprising parallel connecting segments 48 between apical segments 45. The apical segments 45 each comprise an inner radius 47 and an outer radius 48, improving the flow of current and the mechanical stability. To avoid so-called current sinks, the width is enlarged at the apical segments 45. Alternatively or additionally, the conductor pads on the apical segments may exhibit a greater thickness of material.

Further, contacting locations 43 will be noted in the form of interruptions provided for connection to electric supply lines. These supply lines may for example be connected by a riveted (as so-called piercing contacts), bonded, soldered or welded connection to the heating element 4.

A heating element 4 in the embodiment shown by way of example comprises a support layer 42 functioning as insulator and for example made of a polyurethane foam (PUR foam) and an electrically conductive layer 41 applied thereto, made example of copper and/or a copper alloy, aluminum and/or an aluminum alloy, or a suitable bronze alloy (with various proportions of copper and tin).

The heating element 4 preferably comprises no PTC effects and can therefore be operated continuously at full output.

1. A steering wheel comprising:
a padding;
a grip surface at least partly covering the padding; and
a heating element arranged between the padding and the grip surface, the heating element comprising an electrically conductive layer with a meandering contour along a lengthwise direction of the heating element, wherein the heating element is cropped from a substantially continuous segment and wherein the electrically conductive layer, at its apical segments, is widened in each instance compared to a connecting segment.

2. A steering wheel according to claim 1, wherein the electrically conductive layer is an integral constituent of the heating element.

3. A steering wheel according to claim 1, wherein the meandering contour of the heating element includes an undulating profile.

4. A steering wheel according to claim 1, wherein the meandering contour of the heating element includes a rectangular, saw tooth or triangular profile.

5. A steering wheel according to claim 1, wherein apical segments of the electrically conductive layer or the heating element, comprise a rounding radius.

6. A steering wheel according to claim 1, wherein an envelope of the apical segments arranged on one side of the direction of lengthwise extension of the heating element overlap, said apical segments each remaining distanced from each other.

7. A steering wheel according to claim 1, wherein envelopes of the apical segments arranged on either side of the direction of lengthwise extension of the heating element are distanced from each other.

8. A steering wheel according to claim 1, wherein a heating element runs around the entire circumference of the steering wheel.

9. A steering wheel according to claim 1, wherein the heating element runs around a peripheral segment of the steering wheel, cutting out a lower segment between hand grip positions.

10. A steering wheel according to claim 1, comprising two heating elements, each arranged in a circumferential segment of a hand grip position.

11. A steering wheel according to claim 1, wherein the heating element comprises at least two layers connected to each other.

12. A steering wheel according to claim 11, wherein the electrically conductive layer is applied to an insulating support layer and connected thereto.

13. A steering wheel according to claim 12, wherein the insulating support layer is made of synthetic material.

14. A steering wheel according to claim 1, wherein the electrically conductive layer comprises copper or a copper alloy.

15. A steering wheel according to claim 1, wherein the electrically conductive layer comprises aluminum or an aluminum alloy.

16. A steering wheel according to claim 12, wherein the electrically conductive layer is vapor deposited on the insulating support layer.

17. A steering wheel according to claim 12, wherein the electrically conductive layer is applied to the insulating support layer galvanically or by sputtering.

18. A steering wheel according to claim 1, wherein the electrically conductive layer comprises a greater thickness of material at each of its apical segments than the connecting segments.

19. A steering wheel according to claim 1, wherein the electrically conductive layer (41) comprises a plurality contacting locations for connection of supply lines.

20. A steering wheel according to claim 19, wherein the contacting locations each comprise a thickening in the form of a widening or a greater thickness of material of metallization.

21. A steering wheel according to claim 19, wherein the heating element comprises two electric contactings.

22. A steering wheel according to claim 21, wherein, at each electric contacting, an electrically conductive cable connection is provided.

23. A steering wheel according to claim 22, wherein the contactings are made in the form of riveted, soldered, bonded or welded connections.

24. (canceled)

25. (canceled)

26. A steering wheel according to claim 1, wherein the heating element is bonded under the outer grip surface of the steering wheel onto the padding or foaming of a steering wheel rim.

27. A steering wheel according to claim 1, wherein the heating element is bonded onto an inside of the outer grip surface of the steering wheel which is applied to the padding or foaming (24) of a steering wheel rim.

28. A steering wheel according to claim 1, wherein an outer grip surface comprises natural or artificial leather.

29. A steering wheel according to claim 12, wherein the insulating support layer comprises a thickness of material between 30 and 200 microns.

30. A steering wheel according to claim 12, wherein the insulating support layer comprises a thickness of material between 50 and 80 microns.

31. A steering wheel according to claim 11, wherein the electrically conductive layer comprises a thickness of material of about 50 microns.

32. A steering wheel according to claim 11, wherein the electrically conductive layer comprises a thickness of material of about 20 microns.

33. A steering wheel according to claim 11, wherein the electrically conductive layer comprises a thickness of material of about 10 microns.

34. A steering wheel according to claim 1, wherein the heating element is adapted to a predetermined diameter and thickness of a steering wheel rim.

35. (canceled)

36. An electrically heatable steering wheel for a vehicle comprising:
a padding;
a grip surface at least partly covering the padding; and
a heating element arranged between the padding and the grip surface, the heating element comprising an electrically conductive layer with a meandering contour along a lengthwise direction of the heating element and applied to an insulating support layer, the electrically conductive layer including alternating apical segments and connecting segments, the apical segments being wider or thicker than the connecting segments,
wherein the heating element runs around at least a peripheral segment of the steering wheel and wherein the meandering contour is substantially continuous and repeating.

37. A heating element for a vehicle steering wheel comprising:
an electrically conductive layer with a meandering contour along a lengthwise direction of the heating element and applied to an insulating support layer, the electrically conductive layer including alternating apical segments and connecting segments, the apical segments being wider or thicker than the connecting segments,
wherein the meandering contour is formed as a substantially continuous segment such that heating element segments can be cropped therefrom.
